(19) United States
(12) Patent Application Publication
(10) Pub. No.: US 2024/0427637 A1
(43) Pub. Date: Dec. 26, 2024

(54) ADAPTIVE RESOURCE DIMENSIONING FOR CLOUD STACK HAVING PLURALITY OF VIRTUALIZATION LAYERS

(71) Applicant: Telefonaktiebolaget LM Ericsson (publ), Stockholm (SE)

(72) Inventors: Róbert SZABÓ, Budapest (HU); Carla MOURADIAN, Montreal (CA); Ákos RECSE, Halasztelek (HU); Wubin LI, Kirkland (CA)

(21) Appl. No.: 18/700,476

(22) PCT Filed: Oct. 14, 2021
(86) PCT No.: PCT/IB2021/059469

§ 371 Date: Apr. 11, 2024

(51) Int. Cl. G06F 9/50

(52) U.S. Cl. CPC G06F 9/5027

(57) ABSTRACT

A method is provided performed by a network node for adaptive resource dimensioning for a cloud stack having a plurality of virtualization layers with resource dependencies between the plurality of virtualization layers in an infrastructure. The method includes assigning a workload to a bin in the infrastructure based on one of (i) the bin has a resource capacity that supports a dimension of the workload, and (ii) when the resource capacity of the bin is insufficient (a) create a new bin, and (b) assign the workload to the new bin having a dimensioned resource capacity. The method further includes outputting information representing one of the assigned bin and the assigned new bin for the workload, and a corresponding resource capacity of the assigned bin or the dimensioned resource capacity of the new bin.

### TECHNICAL FIELD

The present disclosure relates generally to methods for adaptive resource dimensioning for a cloud stack having a plurality of virtualization layers, and related methods and apparatuses.

### BACKGROUND

FIG. 1 is a block diagram illustrating an example of a distributed cloud 100 that includes access sites/central office (CO)/Enterprise on-premises sites 103, local/regional sites 105, and national sites 107. A distributed cloud (e.g., distributed cloud 100) can combine the best of telecommunications (e.g., running services 101) and cloud technology. Further, a distributed cloud can run an application (App) across multiple sites, as illustrated in FIG. 1. National sites 107 can be used for centralized applications, and regional sites 105 and access sites 103 can provide cloud capabilities closer to end-users and can be used to host applications that require low latency.

On the other hand, with cloud technologies (e.g., virtualization) as the enabler, each site may be equipped with multiple virtualization layers (also referred to as multi-layer cloud stacks), such as e.g. OpenStack (OS) and/or Kubernetes (K8S). Workloads can be hosted in different virtualization layers. FIGS. 2A-2C are block diagrams illustrating examples of deployment types and cloud stack layers. An application-specific workload can be assigned to virtual machines (VMs) in OpenStack (FIG. 2A); assigned as a container application in a Kubernetes cluster on bare metal (FIG. 2B); or within OpenStack, there can be a Kubernetes cluster, and the application-specific workload can be assigned as a container application in virtual machine (VM) based Kubernetes in OpenStack (FIG. 2C).

### SUMMARY

For automation of multi-layer cloud stacks, there currently exist certain challenges for VM bin packing. Challenges include a recurring bin packing problem where items of different size are to be packed into other items of flexible sizes, then in other items of flexible sizes, and so on until an item with a fixed size has been reached. Solutions to such a recurring bin packing problem are lacking.

Certain aspects of the disclosure and their embodiments may provide solutions to these or other challenges. A method for adaptive resource dimensioning for a cloud stack having a plurality of virtualization layers with resource dependencies between the plurality of virtualization layers in an infrastructure is provided. The method may provide a solution to a recurring bin packing problem.

In various embodiments, a method is provided performed by a network node for adaptive resource dimensioning for a cloud stack having a plurality of virtualization layers with resource dependencies between the plurality of virtualization layers in an infrastructure. The method comprises assigning a workload to a bin in the infrastructure based on one of (i) assign the workload to the bin when the bin has a resource capacity that supports a dimension of the workload, the bin comprising one of an existing bin and an existing sub-bin within the bin; and (ii) when the resource capacity of the bin is insufficient to support the dimension of the workload (a) create a new bin, the new bin having a dimensioned resource capacity that supports the dimension of the workload, and (b) assign the workload to the new bin having the dimensioned resource capacity that supports the dimension of the workload. The method further comprises outputting information representing one of the assigned bin and the assigned new bin for the workload, and a corresponding resource capacity of the assigned bin or the dimensioned resource capacity of the new bin.

In other embodiments, a network node for adaptive resource dimensioning for a cloud stack having a plurality of virtualization layers with resource dependencies between the plurality of virtualization layers in an infrastructure is provided. The network node includes at least one processor; and at least one memory connected to the at least one processor and storing program code that is executed by the at least one processor to perform operations. The operations include to assign a workload to a bin in the infrastructure based on one of (i) assign the workload to the bin when the bin has a resource capacity that supports a dimension of the workload, the bin comprising one of an existing bin and an existing sub-bin within the bin; and (ii) when the resource capacity of the bin is insufficient to support the dimension of the workload (a) create a new bin, the new bin having a dimensioned resource capacity that supports the dimension of the workload, and (b) assign the workload to the new bin having the dimensioned resource capacity that supports the dimension of the workload. The operations further comprise to output information representing one of the assigned bin and the assigned new bin for the workload, and a corresponding resource capacity of the assigned bin or the dimensioned resource capacity of the new bin.

In other embodiments, a network node for adaptive resource dimensioning for a cloud stack having a plurality of virtualization layers with resource dependencies between the plurality of virtualization layers in an infrastructure is adapted to perform operations. The operations include to assign a workload to a bin in the infrastructure based on one of (i) assign the workload to the bin when the bin has a resource capacity that supports a dimension of the workload, the bin comprising one of an existing bin and an existing sub-bin within the bin; and (ii) when the resource capacity of the bin is insufficient to support the dimension of the workload (a) create a new bin, the new bin having a dimensioned resource capacity that supports the dimension of the workload, and (b) assign the workload to the new bin having the dimensioned resource capacity that supports the dimension of the workload. The operations further comprise to output information representing one of the assigned bin and the assigned new bin for the workload, and a corresponding resource capacity of the assigned bin or the dimensioned resource capacity of the new bin.

In other embodiments, a computer program comprising program code to be executed by processing circuitry of a network node is provided, whereby execution of the program code causes the network node to perform operations. The operations include to assign a workload to a bin in the infrastructure based on one of (i) assign the workload to the bin when the bin has a resource capacity that supports a dimension of the workload, the bin comprising one of an existing bin and an existing sub-bin within the bin; and (ii) when the resource capacity of the bin is insufficient to support the dimension of the workload (a) create a new bin, the new bin having a dimensioned resource capacity that supports the dimension of the workload, and (b) assign the workload to the new bin having the dimensioned resource capacity that supports the dimension of the workload. The operations further comprise to output information representing one of the assigned bin and the assigned new bin for the workload, and a corresponding resource capacity of the assigned bin or the dimensioned resource capacity of the new bin.

In other embodiments, a computer program product comprising a non-transitory storage medium including program code to be executed by processing circuitry of a network node is provided, whereby execution of the program code causes the network node to perform operations. The operations include to assign a workload to a bin in the infrastructure based on one of (i) assign the workload to the bin when the bin has a resource capacity that supports a dimension of the workload, the bin comprising one of an existing bin and an existing sub-bin within the bin; and (ii) when the resource capacity of the bin is insufficient to support the dimension of the workload (a) create a new bin, the new bin having a dimensioned resource capacity that supports the dimension of the workload, and (b) assign the workload to the new bin having the dimensioned resource capacity that supports the dimension of the workload. The operations further comprise to output information representing one of the assigned bin and the assigned new bin for the workload, and a corresponding resource capacity of the assigned bin or the dimensioned resource capacity of the new bin.

### BRIEF DESCRIPTION OF DRAWINGS

The accompanying drawings, which are included to provide a further understanding of the disclosure and are incorporated in and constitute a part of this disclosure, illustrate certain non-limiting embodiments of this disclosure. In the drawings:

FIG. 1 is a block diagram illustrating an example of a distributed cloud;

FIGS. 2A-2C are block diagrams illustrating examples of deployment types and cloud stack layers;

FIG. 3 is a schematic illustrating actors and models in a system in accordance with some embodiments of the present disclosure;

FIG. 4 is a block diagram of a digital twin in accordance with some embodiments of the present disclosure;

FIG. 5 is a flowchart illustrating operations performed by a network node to find a bin in accordance with some embodiments of the present disclosure;

FIG. 6 is a flowchart illustrating operations performed by a network node to find a bin in accordance with some embodiments of the present disclosure;

FIG. 7 is a flowchart illustrating operations performed by a network node to extend a bin in accordance with some embodiments of the present disclosure;

FIG. 8 is a flowchart illustrating operations performed by a network node to calculate extra capacity of a bin in accordance with some embodiments of the present disclosure;

FIG. 9 is a block diagram visually illustrating information output by a method in accordance with some embodiments of the present disclosure;

FIG. 10 is a block diagram illustrating elements of a network node according to some embodiments of the present disclosure; and

FIGS. 11-16 are flow charts illustrating operations of a network node according to some embodiments of the present disclosure.

### DETAILED DESCRIPTION

The present disclosure will now be described more fully hereinafter with reference to the accompanying drawings, in which examples of embodiments of this disclosure are shown. Embodiments of the present disclosure may, however, be embodied in many different forms and should not be construed as limited to the embodiments set forth herein. Rather, these embodiments are provided so that this disclosure will be thorough and complete, and will fully convey the scope of present embodiments to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

While hosting of workloads in different virtualization layers may bring flexibility for service provisioning, it also increases the complexity of lifecycle management (LCM) during service instance design and assignment. For example, cloud and networking resources can be overprovisioned due to a lack of an automated mechanism to scale up/down or in/out of cloud and networking resources according to their use. There is a need for adaptive dimensioning of cloud layers to smooth (e.g., significantly smooth) the process of service provisioning and better utilization of virtualization layers resources.

An existing approach for resource dimensioning places mobile edge computing (MEC) nodes at each candidate location. See e.g., P. Zhao and G. Dan, “Joint Resource Dimensioning and Placement for Dependable Virtualized Services in Mobile Edge Clouds,” IEEE Transactions on Mobile Computing, DOI 10.1109/TMC.2021.3060118 (18 Feb. 2021) (“Zhao”). Zhao references another approach to compute placement of primary and secondary instances for virtualized services (VSs) over the MEC nodes. Resource dimensioning discussed in Zhao involves determining the location, the number of MEC nodes, and the amount of MEC resources to be deployed.

Another approach regarding resource dimensioning includes a framework to monitor and dynamically dimension resources during the execution of parallel workflows in clouds. See e.g., Coutinho, R., Frota, Y., Ocaña, K. et al., “A Dynamic Cloud Dimensioning Approach for Parallel Scientific Workflows: A Case Study in the Comparative Genomics Domain”, J Grid Computing 14, 443-461 (2016) (“Coutinho”). Coutinho describes monitoring the resources usage of VMs and estimating the number of VMs to instantiate for workflows execution.

In another approach regarding resource dimensioning, a service is described based on a multi-objective cost function to determine an initial configuration for a virtual cluster. See e.g., Daniel de Oliveira, Vitor Viana, Eduardo Ogasawara, Kary Ocana, and Marta Mattoso, “Dimensioning the virtual cluster for parallel scientific workflows in clouds,” Proceedings of the 4th ACM workshop on Scientific cloud computing (Science Cloud '13). Association for Computing Machinery, New York, NY, USA, 5-12, 2013 (“Oliveira”). Oliveira describes a decision based on workflow characteristics with budget and deadline constraints; and defining an optimal/near-optimal number of VMs according to the type of VMs provided by the cloud. The dimensioning is done before the workflow execution in the cloud.

VM packing, bin packing, and knapsack packing will now be discussed.

A goal of packing problems is to find the best way to pack a set of items of given sizes into bins with fixed capacities. In a packing problem known as bin packing, there can be multiple bins of equal capacity. A goal in such bin packing is to find the smallest number of bins that will hold all the items (also referred to herein as workloads).

A VM placement or VM packing problem can be seen as a type of bin packing problem, where an aim is to pack or place a set of VMs instances to physical servers such that the number of physical servers is minimized. Both bin packing and VM placement problems have been discussed as being non-deterministic polynomial-time (NP) hard problems. For example, S. Rampersaud and D. Grosu, “Sharing-Aware Online Virtual Machine Packing in Heterogeneous Resource Clouds,” IEEE Transactions on Parallel and Distributed Systems, vol. 28, no. 7, pp. 2046-2059, 1 Jul. 2017 (“Rampersaud”), discusses a sharing-aware VM packing problem which has the same objective as a standard VM packing problem (i.e., minimize the number of the bins), but allows the VM instances collocated on the same physical server to share memory pages, thus reducing the amount of allocated cloud resources.

A VM packing problem can also be considered as a multi-dimensional (MDBPP) or multi-capacity bin packing (MCBPP) problem. MDBPP and MCBPP are two versions of a bin packing problem. In MCBPP, each bin has multiple capacities, and each item has multiple weights. In Bassem, C., Bestavros, A.: “Multi-Capacity bin packing with dependent items and its application to the packing of brokered workloads in virtualized environments”, Future Gener. Comput. Syst. 72, 129-144 (2017) (“Bassem”), the MCBPP version was considered for resource allocation in the cloud. Bassem considered multi-dimensional bins, where each dimension represents a resource it offers (e.g., network, CPU). The resources consumed over a bin's different dimensions are function of the items packed into that bin and can vary according to the collocation of the items.

In another approach, the MDBPP version was considered for VM packing. A difference between MCBPP and MDBPP is that in MCBPP, once an item is packed into a bin, its resources (e.g., CPU, memory) cannot be allocated to another item in that bin. While in the MDBPP problem, the capacity can be shared and is not dedicated to a single item. For example, Pachorkar N, Ingle R., “Multi-dimensional affinity aware VM placement algorithm in cloud computing”, Int J Adv Comput Res. 2013; 3(4):121 (“Pachorkar”) considered MDBPP class for VM packing. Pachorkar considered multiple dimensions (e.g., CPU, memory) together when allocating VMs to Physical Machines (PMs). Memory and network affinity were also considered among the VMs during VM placement. Pachokar describes that, after initial placement of VMs on different PMs, a system finds the memory and network affinity between different VMs hosted on different PMs and tries to place these VMs on the same PM.

In knapsack packing, there is a single container/knapsack, and the items have values and sizes. A goal is to pack a subset of items that have a maximum total value. Unlike the bin packing problem, the number of bins is fixed. El Motaki, S., Yahyaouy, A., Gualous, H. et al, “Comparative study between exact and metaheuristic approaches for virtual machine placement process as knapsack problem”, J Supercomput 75, 6239-6259 (2019) (“Motaki”), discuss use of the knapsack packing problem for the VM packing problem. Camati RS, Lima L Jr, Calsavara A, “Solving the virtual machine placement problem as a multiple multidimensional knapsack problem”, ICN 2014: The Thirteenth International Conference on Networks (“Camati”) discusses using a multidimensional multiple knapsack packing version to solve a VM placement problem. In multi-dimensional knapsack packing, items have more than one quantity such as weight and volume, and the knapsack has a capacity for each quantity. In a multiple knapsack problem, there are multiple knapsacks and a goal is to maximize the total value of packed items in all knapsacks. Camati describes a goal to maximize the placement ratio, considering the number of placed VMs and the total number of requests in the queue. The maximum capacity of knapsacks were chosen statically.

In another approach, some challenges are discussed for existing algorithms (e.g., First Fit, Best Fit) to solve the packing problem for VM placement. See e.g., Kumaraswamy, S., & Nair, M. K., “Bin packing algorithms for virtual machine placement in cloud computing: A review”, International Journal of Electrical and Computer Engineering, 9 (1), 512-524 (2019) (“Kumaraswamy”). A challenge is that there may be affinity rules between two VMs in which they may be required to be placed together on the same bin. Another challenge may be that existing algorithms do not consider dynamic VM capacity since VMs cannot be static over their lifetime. This is also applicable for bin sizes.

Thus, in the approaches described above, bin packing, VM packing, and knapsack packing have been referred to as NP-hard problems for which different heuristics have been described.

In the context of automation of multi-layer cloud stacks, the VM packing problem may be further extended to a recurring (also referred to as embedded) bin packing problem, where items of different size must be packed into other items of flexible sizes, then in other items of flexible sizes, and so on until an item with a fixed size is reached. Existing approaches, e.g. approaches discussed above, lack a solution to such a problem. While some approaches discuss resources dimensioning of a single layer of cloud stacks, e.g., VMs, dependencies and hierarchies of cloud stack layers are ignored.

Certain aspects of the disclosure and their embodiments may provide solutions to these or other challenges.

Various embodiments of the present disclosure include a method for adaptive resource dimensioning of cloud stacks with multiple virtualization layers during service instance design and assign time. The method can be an extension to a workload assignment workflow. In some embodiments, the method handles resource dependencies between virtualization layers, e.g., OpenStack and Kubernetes.

In some embodiments, a dynamic model is created for the problem, where the size of an item(s) is defined in multiple dimensions (e.g., CPU, memory, and storage capacity) and consumed by their inner (also referred to as “child”) items accordingly. An item itself consumes volumes (e.g., resources) from the bin (e.g., parent) it is packed into, therefore the volume (e.g., resources) it offers to its child is less than or equal to the volume (e.g., resources) it consumes from its parents. The difference between the consumed and offered volume (e.g., resources) is the item's overhead. Physical resources space (e.g., CPUs) is converted to virtual resources space (e.g., virtual central processing units (vCPUs)) while maintaining the connection between the physical and virtual resources. This conversion is transparent to the workload assignment workflow.

In some embodiments, the dynamic method can be applied to multi-layered software virtualization, where items and bins can be servers, virtualization layers, or applications.

In some embodiments, during a virtual network function (VNF) embedding problem, some of the items discussed above are immutable while other items are mutable for a time window. In an example embodiment, instead of pre-defining a resource requirement of a virtualization layer (e.g., a K8S cluster), during a workload assignment process, the method considers these as dynamically resizable entities. In some embodiments, a resource requirement of earlier placed virtualization elements is adjusted.

In some embodiments, the method includes a heuristic VNF embedding algorithm, which homes/assigns VNFs to recurring virtualization layers which are designed and dimensioned in runtime.

Certain embodiments may provide one or more of the following technical advantages. The method may solve a multi-layered and multi-dimensional bin packing problem, where each item may appear as a bin for other items using adaptive dimensioning that considers a hierarchical relationship of virtualization layers, including that a change in a component's resource requirement may affect ancestor or successor nodes in the hierarchy. As a consequence, better utilization of system resources may be obtained. For example, instead of overprovisioning/under-provisioning, a resource footprint of virtualization layers may be intelligently adjusted, and less virtualization layer overhead may be incurred.

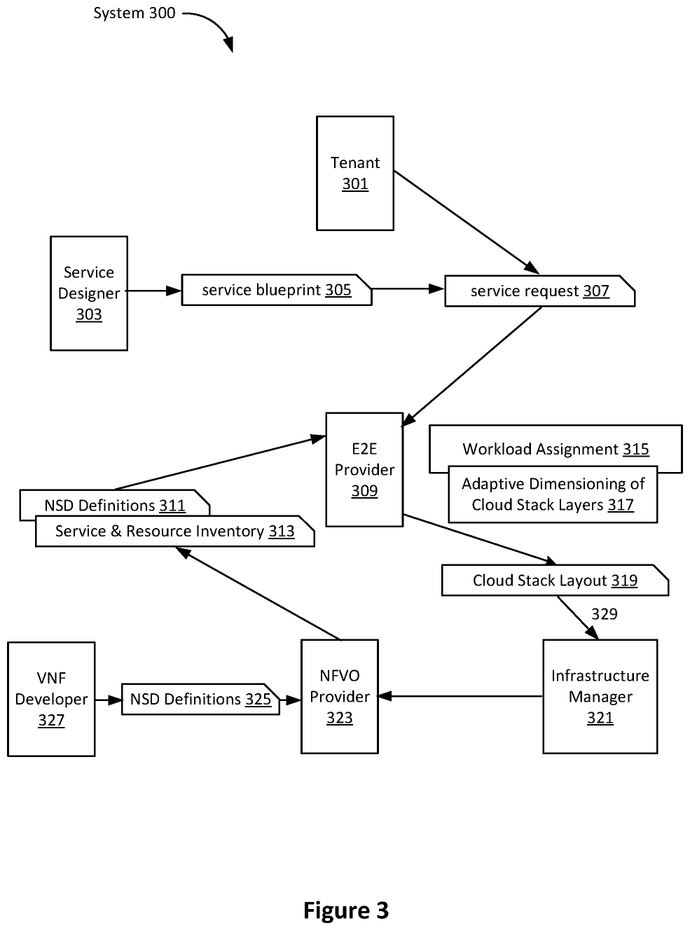

FIG. 3 is a schematic illustrating actors and models in a system 300 in accordance with some embodiments of the present disclosure. FIG. 3 includes a workload assignment 315 and adaptive cloud stack dimensioning engine 317, which can assign resources to service context enriched service blueprints 305 based on the available resources and network service descriptors (NSD) packages 311, 325 provided by subordinated orchestration subsystems (e.g., by VNF developer 327, etc.). When a service request 307 from a tenant 301 arrives at an end-to-end (E2E) service orchestration provider 309 (e.g., an end-user, an enterprise, a third-party provider, the service provider itself, etc.), the arrival triggers workload assignment 315 and cloud stack adaptive dimensioning process 317. In some embodiments, the service request 307 can have input parameters from tenant 301 and can be complemented with associated policies stored in E2E service orchestration provider 309.

Still referring to FIG. 3, implementation of a cloud stack layout 319 then can be executed by an infrastructure manager 321. Arrow 329 embeds the adaptive dimensioning process of cloud stacks. The embedding may go on more than one time if a stack layer further requires other layers on a lower level (e.g., a K8S layer may require an OS layer underneath). With the cloud stacks prepared, network functions virtualization orchestrator (NVFO) 323 can implement the VNF assignment accordingly.

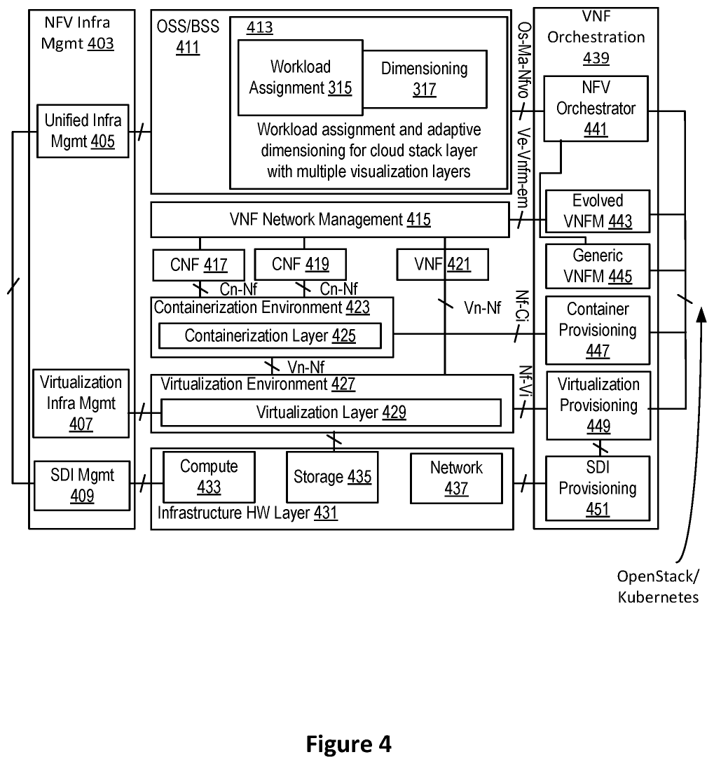

FIG. 4 is a block diagram of a digital twin maintained by an adaptive resource dimensioning for cloud stacks with multiple virtualization layers extension to workload assignment in accordance with some embodiments of the present disclosure. The digital twin includes components including an infrastructure layer 431, virtualization environment 427, container environment 423, workload assignments (cloud-native network functions (CNFs) 417, 419 and VNFs 421), NFV Infrastructure management 403, and VNF Orchestration 439. A network node, e.g., operation support system (OSS)/business support system (BSS) node 413, includes workload assignment 315 and adaptive cloud stack dimensioning engine 317. Workload assignment 315 and adaptive cloud stack dimensioning engine 317 can perform resource dimensioning for cloud stack layers with multiple virtualization layers. While FIG. 4 depicts workload assignment 315 and adaptive cloud stack dimensioning engine 317 as two boxes, in practice, workload assignment 315 and adaptive cloud stack dimensioning engine 317 may be within a single component.

Still referring to FIG. 4, in some embodiments, workload assignment 315 and adaptive cloud stack dimensioning engine 317 together can maintain the digital twin of the underlying physical and virtual systems for simulation purposes. For the digital twin, workload assignment 315 maintains models of CNF 417, 419, VNF 421, NFV orchestrator 441, Evolved virtual network function manager (VNFM) 443, generic VNFM 445, and container provision 447; and adaptive cloud stack dimensioning engine 317 maintains models of unified infrastructure management 405, virtualization management 407, software-defined infrastructure (SDI) management 409, containerization environment 427, virtualization layer 429, infrastructure hardware layer 431 and SDI provisioning 451. The joint simulation contains the lifecycle models and their interactions for the two sub-systems of the digital twin maintained by workload assignment 315 and adaptive cloud stack dimensioning engine 317, respectively. In some embodiments, a system and/or component belongs to both workload assignment 315 and adaptive cloud stack dimensioning engine 317, e.g., virtualization provisioning 449.

Still referring to FIG. 4, the joint resource dimensioning 317 and workload assignment 315 designs change and simulates their effects on all the layers and management components. By repeating multiple design-change-effect-learn cycles, the joint resource dimensioning 317 and workload assignment 315 can evaluate steps necessary to all the layers to support a service instantiation, update, or assurance. In some embodiments, when a master plan involving all the changes to the different layers is created, a break-down and ordered sequence of batch actions (execution plan) is created for NFV infrastructure management 403 and VNF orchestration 439.

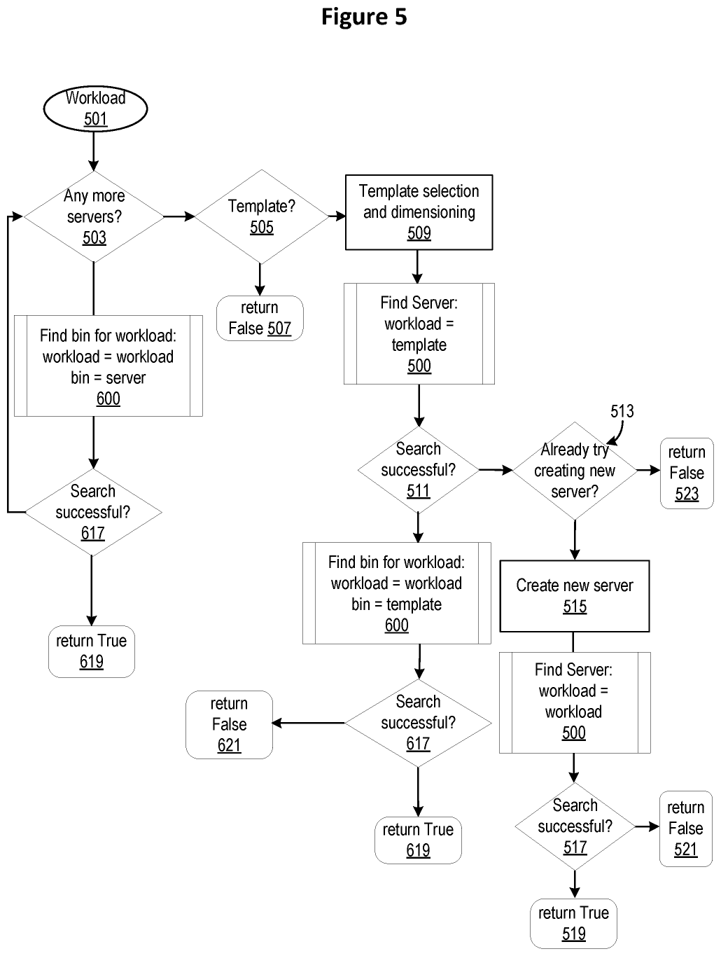

Operations of the method will now be discussed further with respect to an example embodiment. While the example embodiment is explained in the non-limiting context of the following sequence of operations from FIGS. 5-8, the operations noted may occur out of the order noted. For example, two operations may be described in succession but may in fact be executed substantially concurrently or the operations may sometimes be executed in the reverse order, depending upon the operations involved. Moreover, the operations may be separated into multiple operations and/or the operations of two or more operations may be at least partially integrated. Finally, other operations may be added/inserted between the operations blocks that are described, and/or operations may be omitted without departing from the scope of the present disclosure.

Referring first to FIG. 5, FIG. 5 is a flowchart illustrating operations performed by a network node to find a server (“Find Server process”) in a method for adaptive dimensioning of cloud stack layers in accordance with some embodiments of the present disclosure. In the example embodiment of FIG. 5, the Find Server process begins 501 with a workload. Given the workload, the Find Server process produces (1) an infrastructure layout (with multiple virtualization layers if needed) accordingly, (2) a workload assignment within the layout, and (3) each virtualization layer (if exists) is constructed with appropriate capacity dimensioned.

Still referring to FIG. 5, the Find Server process iterates 503 through existing servers.

For the selected server iteration 503, a second process to find a bin for the workload (“Find Bin process”) is called 600. The Find Bin process is called in order to check whether the workload can be assigned to a bin within the current server. If yes 617, the whole process stops and returns 619 True, otherwise, the next server is checked in iteration 503.

If there are no more servers to check in iteration 503, the Find Server process selects 505, 509 the best bin template for the workload. The rationale to try to allocate a bin is that the genuine workload may not be directly packable to servers but only to some container bins (e.g., VM). The selected bin template will be treated as a workload to recursively call the Find Server process 500. To help ensure that the capacity requirements of the workload can be fulfilled, when the template is selected 509, its capacity is also dimensioned accordingly. In a further example embodiment, in a case where the workload (e.g., a K8S node, requiring 6 virtual central processing units (vCPUs)) needs to be packed in a VM, a VM template will be selected. The capacity of this VM will be at least the sum of the workload requirement and the virtualization overhead (e.g., K8S layer over a VM layer), which is 8 vCPUs if the overhead is 2 vCPUs.

If the bin template (as a workload) can be successfully assigned 511, then the Find Server process goes to the Find Bin process 600 for the workload to check 617, 619, 621 whether the workload can be assigned to the newly created bin. It is noted that the workload is swapped back to the object (bin or workload), which initiated the template selection.

Otherwise, the Find Server process tries to create 515 a new server and call the Find Server process again. It is noted this effort is tried 513, 523 one time. For purposes of discussion, and without loss of generality, it is assumed that a new server (in other words, an empty server) 517, 519 can accommodate any genuine workload with any number of dependent bin requirements. If servers can be of different resource dimensions, then one needs to either start with the biggest server or iterate through different server sizes before concluding that an allocation is not possible.

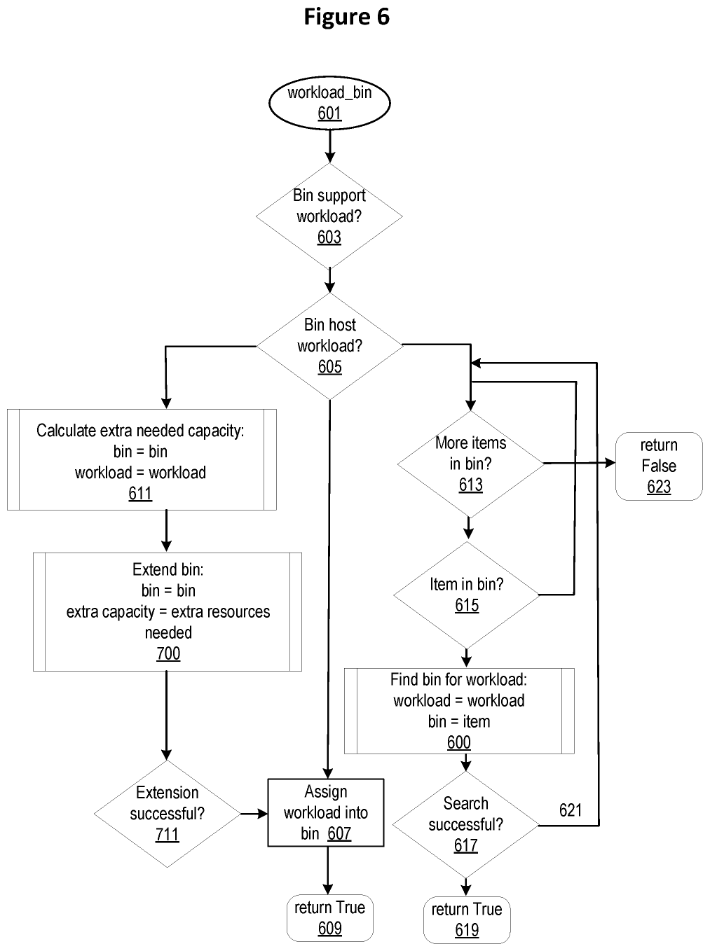

Referring next to FIG. 6, FIG. 6 is a flowchart illustrating operations performed by a network node to find a bin for the workload (i.e., the Find Bin process 600) in accordance with some embodiments of the present disclosure. The Find Bin process 600 is performed to find a bin where a given workload can be packed. This element can be the bin itself or a sub bin within the bin (e.g., a K8S node within a VM). The Find Bin process starts 601 with a workload and a bin as input parameters.

In operation 603, the Find Bin process 600 check whether the bin supports the workload.

If yes, the Find Bin process 600 checks 605 whether the bin can host the workload. This operation includes checking the capacity of the resource of a bin that is needed to host the workload. If the bin has enough resources to host the workload, the workload is assigned 615 to the bin. If the bin does not have enough resources to host the workload, a third process 700 is invoked to extend the resources of the bin (Extend Bin process 700) with a pre-calculated 611 extra capacity. If the bin resources are extended successfully 711, the workload is assigned 607 to the bin.

If the bin does not support the workload, the Find Bin process 600 checks 613, 615 whether there are more items that are sub bins in the bin that can host the workload. If yes, the same process is invoked recursively i.e., the Find Bin process 600 to find a bin for the item.

If there are no more items in the bin, the Find Bin process 600 returns 623 false.

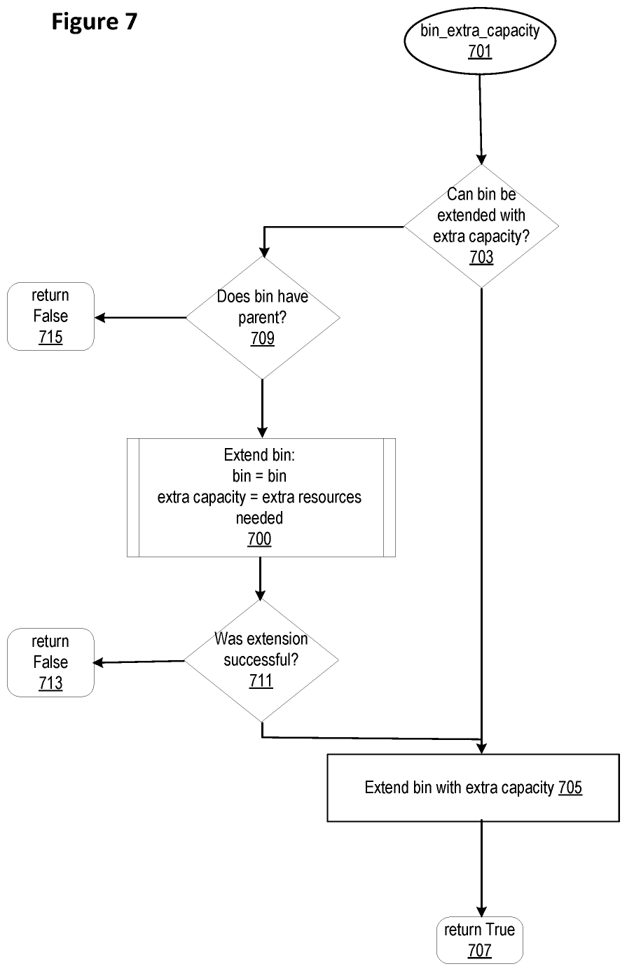

Now referring to FIG. 7, FIG. 7 is a flowchart illustrating operations performed by a network node to extend a bin (i.e., the Extend Bin process 700) in accordance with some embodiments of the present disclosure. This operation is to extend a given bin with a given amount of extra resources. The Extend Bin process 700 starts 701 with a bin and the extra needed capacity as input parameters.

The Extend Bin process 700 checks 703 whether the bin can be extended with a given extra capacity (e.g., a vector of resources for multiple dimensions of extra capacity, such as extra capacity for CPU, memory resources, etc.).

If the bin can be extended, an extension is performed 705.

If not, the Extend Bin process 700 checks 709 whether the bin has a parent. In a further example embodiment, if the bin is a server, then it does not have a parent, hence cannot be extended. If that is the case, the Extend Bin process 700 returns 715 false. If the bin has a parent, the Extend Bin process 700 checks whether the parent can be extended so that an extension of the current bin can be supported. This is done by recursively invoking the Extend Bin process 700.

If the parent bin is not successfully extended 711, the Extend Bin process 700 returns 713 False. It the parent bin can be extended, an extension is performed 705 and the Extend Bin process returns 707 true for the extended parent bin.

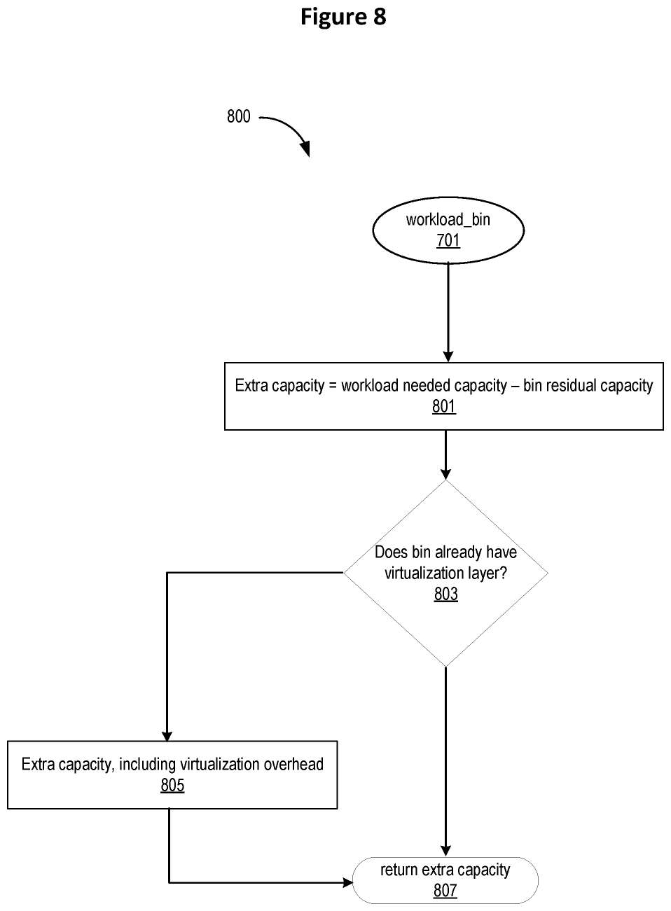

Referring now to FIG. 8, FIG. 8 is a flowchart illustrating operations performed by a network node in process 800 to calculate 611 extra needed capacity of a bin. The process 800 starts 701 with a workload and a bin as input parameters. A minimum 801 for the calculation 611 is the extra capacity requirement of the given workload less the residual capacity of the bin. Operation 803 is performed to determine whether the bin already has a virtualization layer. If no, process 800 returns 807 the calculated extra capacity. If yes, virtualization overhead is also considered 805, and process 800 returns 807 the calculated extra capacity including the virtualization overhead.

A further example embodiment is now discussed. In this example embodiment, each physical server has a capacity of 28 CPUs. It is noted that each server also has a memory capacity, however, for ease of discussion, this example embodiment is directed to the CPU dimension. Further, in the example embodiment, each VM takes 12 CPUs. The virtualization overhead includes (i) hosting a VM layer over a physical layer requires 4 CPUs, and (ii) hosting a K8S layer over a VM requires 2 CPUs. This example embodiment has four workloads (identified as Apps 1-4 below). The following table summarizes the virtualization and capacity requirements for the four workloads, the VM layer, and the K8S layer:

| # | Virtualization requirement | Capacity requirement (#vcpu) |
|---|---|---|
| App1 (CNF) | K8S | 4 |
| K8S | VM | 2 (overhead) |
| VM | NONE (directly on PM) | 4 (overhead) |
| App2 | NONE (directly on PM) | 6 |
| App3 (VNF) | VM | 10 |
| App4 (CNF) | K8S | 3 |

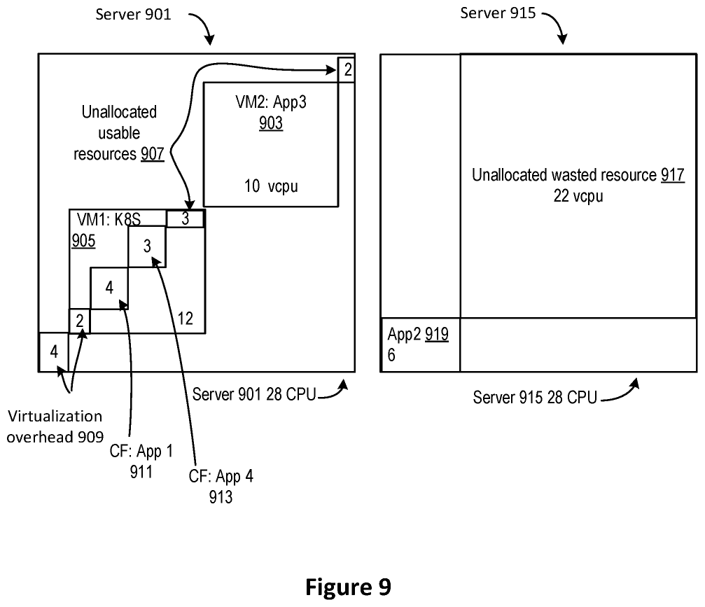

In this example embodiment, performance of the method of the present disclosure produces an output of information for two servers. In accordance with some embodiments, the outputted information is visually illustrated in the block diagram of FIG. 9 including the two servers, server 901 and server 915.

The capacity of each element (App, VM, etc.) are shown in FIG. 9. Server 901 has a capacity of 28 VCPUs. Two VMs are created on server 901, with a virtualization overhead 909 of 4 vCPUs. VM1 905 has a capacity of 12 vCPUs; and is dedicated to serve as a K8S node where App1 911 having a capacity of 4 vCPUs, and App4 913 having a capacity of 3 vCPUs, are assigned. VM1 905 has 3 vCPUs of unallocated usable resources 907 that can be dedicated to another App. As illustrated in FIG. 9, VM1 905 still has 2 vCPUs that are virtualization overhead 909 and cannot be dedicated to another App. VM2 903 has a capacity of 10 vCPUs. App3 is assigned to VM2. Server 901 has 2 vCPUs of unallocated usable resources 907. Server 915 has a capacity of 28 VCPUs, broken down as follows. App2 919 is assigned to server 915 and has a capacity of 6 vCPUs. The remaining 22 vCPUs on server 915, however, are unallocated wasted resource 917 and cannot be shared with other Apps.

In some embodiments, the method models multiple virtualization layers as a hierarchical, multi-instance, multi-dimensional bin packing problem. In some embodiments, this is a recurring bin packing problem, where each item in a bin can become a bin itself hosting other items.

In some embodiments, the method includes an overhead model for the bins corresponding to the real virtualization layers' overheads.

In some embodiments, the method includes a hosting model, which can allow constrained assignment of items to bins (e.g., a container can only be assigned to a container virtualization environment).

In some embodiments, the model includes a heuristic algorithm that adaptively creates and/or resizes bins (e.g., virtualization layers) to accommodate workloads.

In some embodiments, the method designs virtualization layers and workload assignment together.

In some embodiments, the method includes modeling virtualization layer behavior.

In some embodiments, the method includes building a digital twin to simulate virtualization layer lifecycle management actions.

In some embodiments, the method includes determining a virtualization layer sharing strategies.

In some embodiments, the method includes applying a bin-packing technique to organize and dimension virtualization layers for workload hosting.

In some embodiments, the method includes modeling virtualization layer overheads.

In some embodiments, the method includes allocating servers to virtualization layers, virtualization layers to virtualization layers, and workloads to virtualization layers.

In some embodiments, the method includes interleaving the workload assignment with the dimensioning of virtualization layers.

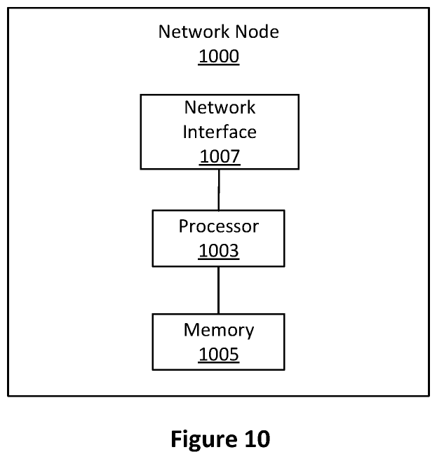

FIG. 10 is a block diagram illustrating elements of a network node 1000 according to embodiments of the present disclosure. A network node refers to equipment capable, configured, arranged, having modules configured to and/or operable to communicate directly or indirectly with a server, data repository, and/or with other network nodes or equipment, in a communication network. Examples of network nodes include, but are not limited to OSS nodes, BSS nodes, and/or cloud-implemented servers or edge-implemented servers.

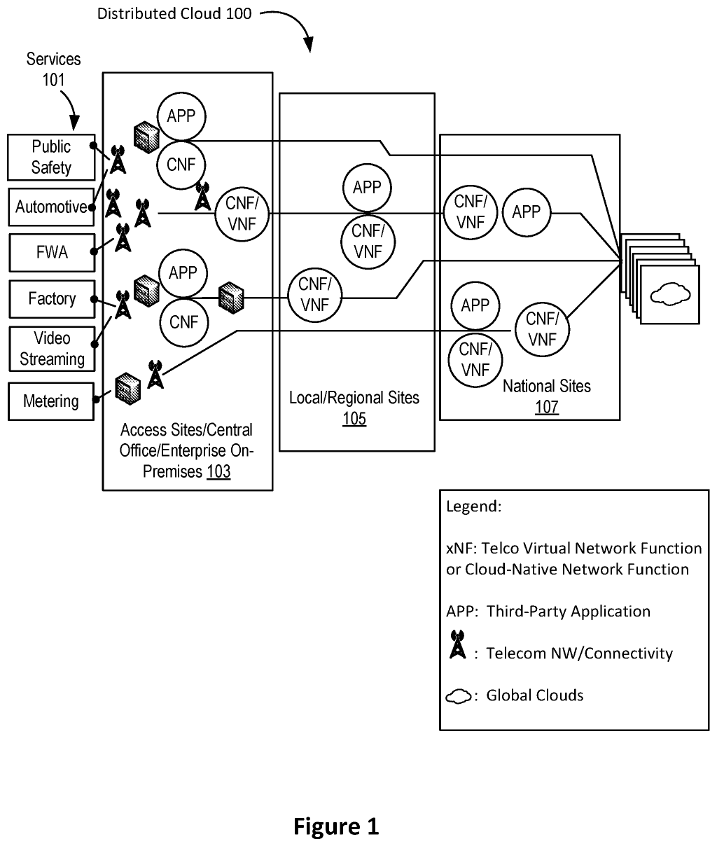

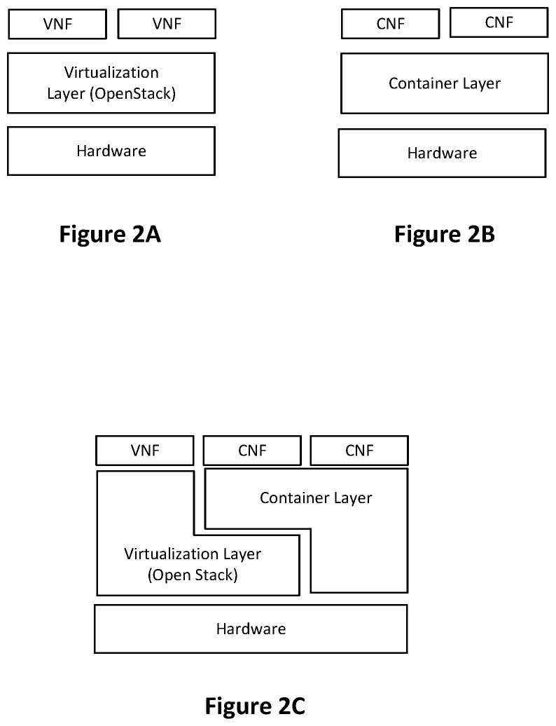

Network node 1000 may be provided, for example, as discussed herein with respect to network node 411 of FIG. 4, a cloud-implemented network node (e.g., a server) or located in the cloud or an edge-implemented network node (e.g., a server), a virtual machine in a cloud deployment, or the network node can be distributed over several virtual machines, containers, or function as a service (FaaS) procedures, all of which should be considered interchangeable in the examples and embodiments described herein and be within the intended scope of this disclosure, unless otherwise noted. All components/modules in FIGS. 1 and 4 can be distributed in a cloud environment.

For ease of discussion, a network node will now be described with reference to FIG. 10. As shown, the network node may include transceiver circuitry (not illustrated) including a transmitter and a receiver configured to provide uplink and downlink radio communications with mobile terminals. The network node may include network interface circuitry 1007 (also referred to as a network interface) configured to provide communications with other nodes (e.g., with other network nodes, servers, and/or data repositories) of a distributed cloud. The network node may also include processing circuitry 1003 (also referred to as a processor) coupled to the transceiver circuitry, and memory circuitry 1005 (also referred to as memory) coupled to the processing circuitry. The memory circuitry 1005 may include computer readable program code that when executed by the processing circuitry 1003 causes the processing circuitry to perform operations according to embodiments disclosed herein. According to other embodiments, processing circuitry 1003 may be defined to include memory so that a separate memory circuitry is not required.

As discussed herein, operations of the network node may be performed by processing circuitry 1003, network interface 1007, and/or transceiver. For example, processing circuitry 1003 may control transceiver to transmit downlink communications through transceiver over a radio interface and/or to receive uplink communications through transceiver over a radio interface. Similarly, processing circuitry 1003 may control network interface 1007 to transmit communications through network interface 1007 to one or more other network nodes and/or to receive communications through network interface from one or more other network nodes, servers, etc. Moreover, modules may be stored in memory 1005, and these modules may provide instructions so that when instructions of a module are executed by processing circuitry 1003, processing circuitry 1003 performs respective operations (e.g., operations discussed herein with respect to example embodiments relating to network nodes). According to some embodiments, network node 1000 and/or an element(s)/function(s) thereof may be embodied as a virtual node/nodes and/or a virtual machine/machines.

According to some other embodiments, a network node may be implemented as a core network node without a transceiver. In such embodiments, transmission to a server, another network node, etc. may be initiated by the network node 1000 so that transmission to the server, network node, etc. is provided through a network node 1000 including a transceiver (e.g., through a base station or radio access network (RAN) node). According to embodiments where the network node is a RAN node including a transceiver, initiating transmission may include transmitting through the transceiver.

Embodiments of the network node may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

Although network node 1000 is illustrated in the example block diagram of FIG. 10, the block diagram may represent a device that includes the illustrated combination of hardware components, other embodiments may comprise network nodes with different combinations of components. It is to be understood that a network node comprises any suitable combination of hardware and/or software needed to perform the tasks, features, functions, and methods disclosed herein. Moreover, while the components of a network node are depicted as single boxes located within a larger box, or nested within multiple boxes, in practice, each device may comprise multiple different physical components that make up a single illustrated component. For example, a memory may comprise multiple separate hard drives as well as multiple RAM modules. In another example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the network nodes as a whole.

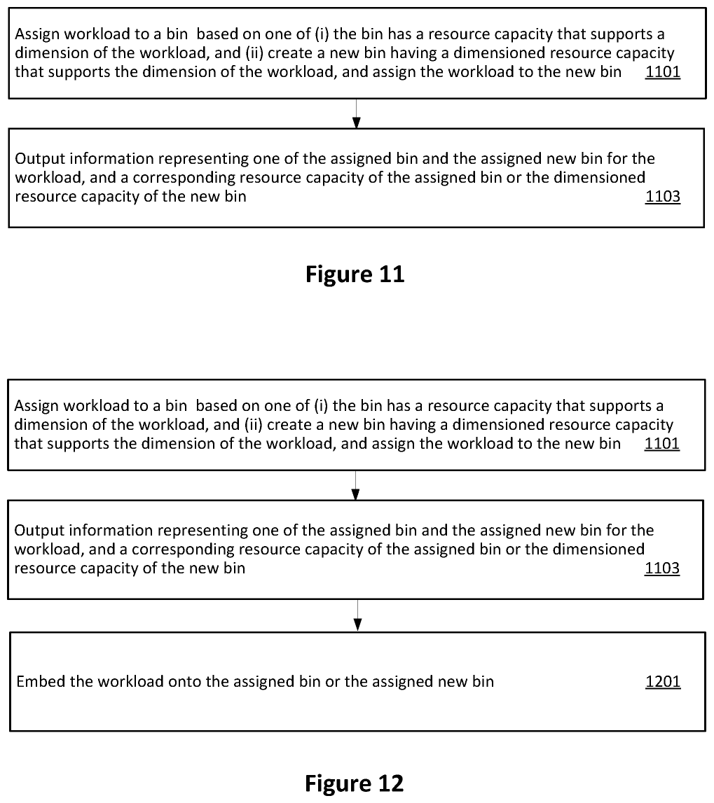

Operations of a network node (e.g., network node 1000) (implemented using the structure of FIG. 10) will now be discussed with reference to the flow charts of FIGS. 11-16 according to some embodiments of the present disclosure. In the description that follows, while the network node may be any of the network node 1000, a virtual machine, a network node distributed over more than one virtual machine, the network node 1000 shall be used to describe the functionality of the operations of the network node. For example, modules may be stored in memory 1005 of FIG. 10, and these modules may provide instructions so that when the instructions of a module are executed by respective network node processing circuitry 1003, processing circuitry 1003 performs respective operations of the flow chart.

Referring to FIG. 11, a method is provided that is performed by a network node (e.g., 411, 1000) for adaptive resource dimensioning for a cloud stack having a plurality of virtualization layers with resource dependencies between the plurality of virtualization layers in an infrastructure. The method includes assigning (1101) a workload to a bin in the infrastructure based on one of (i) assign the workload to the bin when the bin has a resource capacity that supports a dimension of the workload, the bin including one of an existing bin and an existing sub-bin within the bin, and (ii) when the resource capacity of the bin is insufficient to support the dimension of the workload (a) create a new bin. The new bin having a dimensioned resource capacity that supports the dimension of the workload, and (b) assign the workload to the new bin having the dimensioned resource capacity that supports the dimension of the workload. The method further includes outputting (1103) information representing one of the assigned bin and the assigned new bin for the workload, and a corresponding resource capacity of the assigned bin or the dimensioned resource capacity of the new bin.

Referring now to FIG. 12, in some embodiments, the method further includes embedding (1201) the workload onto the assigned bin or the assigned new bin in the infrastructure.

In some embodiments, the existing bin and the new bin, respectively, include a bin that is adaptive over a period of time to be one or more of a physical server, a virtual machine, a virtualization layer from the plurality of virtualization layers, and an application for the workload or for another workload.

In some embodiments, the assigning (1101) the workload to a bin includes performing a first process to find a server. The first process includes (i) iterating through existing servers to select a server, and (ii) for a selected server, checking whether the selected server can host the workload. The assigning (1101) further includes when checking whether the selected server can host the workload, performing a second process to find a bin of the server. The second process including checking whether a bin of the server can support and host the workload and whether the bin has the resource capacity to support the dimension of the workload; and performing one of (i) making the assignment to the bin of the server when the bin of the server has the resource capacity to support the dimension of the workload, and (ii) checking whether there is a sub-bin in the bin of the server that can host the workload when the bin of the server lacks the resource capacity to support the dimension of the workload.

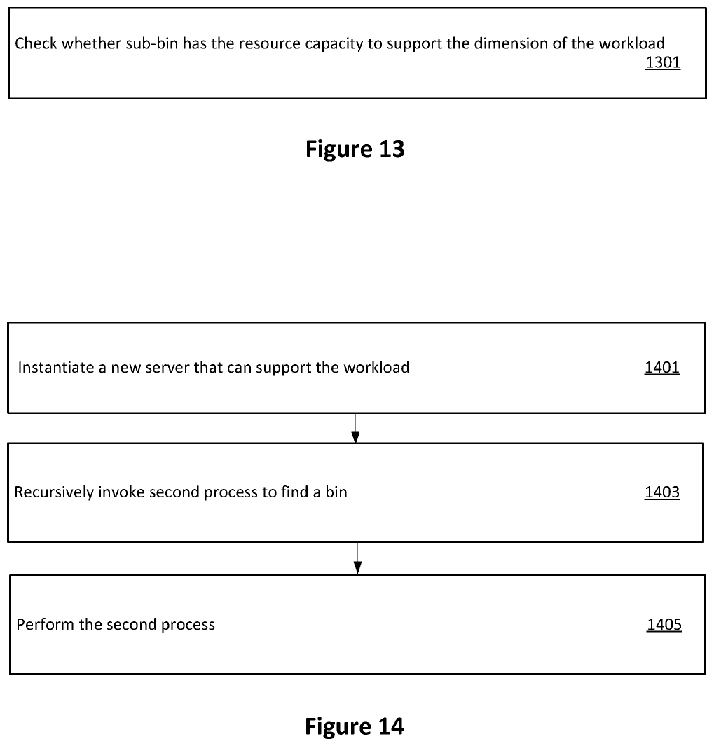

Referring to FIG. 13, in some embodiments, when the sub-bin of the server can host the workload, the method further includes checking (1301) whether the sub-bin has the resource capacity to support the dimension of the workload; and wherein the assigning (1101) includes assigning the workload to the sub-bin when the sub-bin has the resource capacity to support the dimension of the workload.

Referring to FIG. 14, in some embodiments, when the sub-bin of the server can host the workload, the method further includes instantiating (1401) a new server that can support the workload; recursively invoking (1403) the second process to find a bin; and performing (1405) the second process, wherein the server in the second process is the new server.

In some embodiments, the create a new bin includes: selecting a bin template for the workload; dimensioning a capacity of the bin template to result in the dimensioned resource capacity that supports the dimension of the workload; treating the selected bin template as the workload to recursively invoke the second process; recursively invoking the second process; and performing the second process, wherein the bin in the second process is the new bin.

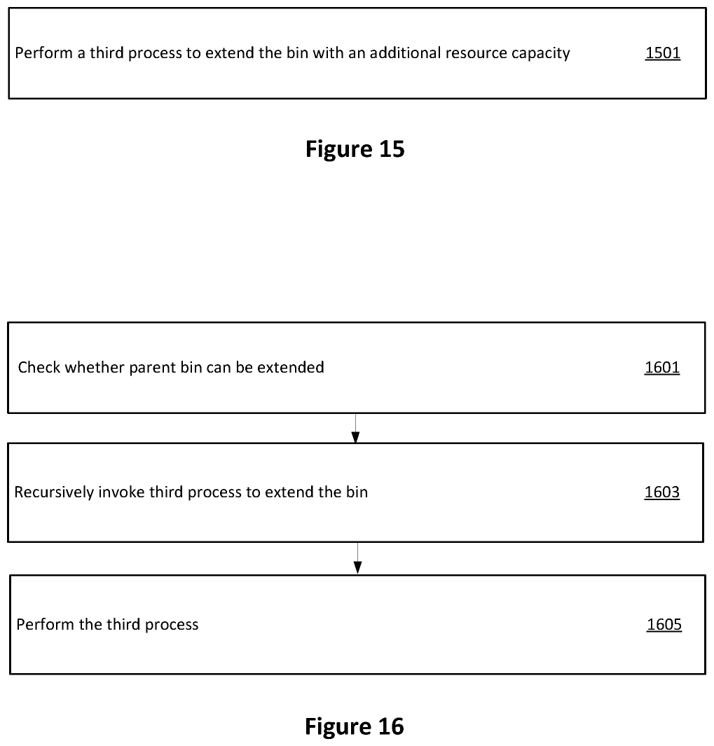

Referring to FIG. 15, in some embodiments, when the bin in the second process lacks the resource capacity to support the dimension of the workload, the method further includes performing (1501) a third process to extend the bin with an additional resource capacity; and wherein the assigning (1101) includes assigning the workload to the extended bin.

In some embodiments, the third process to extend the bin includes checking whether the bin can be extended with the additional resource capacity; and performing one of (i) when the bin can be extended, extending the bin, and (ii) when the bin cannot be extended, checking whether the bin has a parent bin.

Referring to FIG. 16, when the bin has a parent bin, the method further includes checking (1601) whether the parent bin can be extended. When the parent bin can be extended, recursively invoking (1603) the third process to extend the bin; and performing (1605) the third process, wherein the bin in the third process is the parent bin.

In some embodiments, the extending the bin includes calculating the additional resource capacity. The calculating includes one of (i) when the bin has a virtualization layer, determining a difference between the dimension of the workload and a residual capacity of the bin; and (ii) when the bin lacks a virtualization layer, determining the difference between the dimension of the workload and a residual capacity of the bin, and adding a virtualization overhead to the difference.

In some embodiments, the network node includes one of an operation support system (OSS) node and a business support system (BSS) node.

The various operations from the flow charts of FIG. 12-16 may be optional with respect to some embodiments of a method performed by a network node.

Further definitions and embodiments are discussed below.

In the above-description of various embodiments of the present disclosure, it is to be understood that the terminology used herein is for the purpose of describing particular embodiments only and is not intended to be limiting of the present disclosure. Unless otherwise defined, all terms (including technical and scientific terms) used herein have the same meaning as commonly understood by one of ordinary skill in the art to which the present disclosure belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of the present disclosure. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of the present disclosure may be embodied in hardware and/or in software (including firmware, resident software, micro-code, etc.) that runs on a processor such as a digital signal processor, which may collectively be referred to as “circuitry,” “a module” or variants thereof.

Many variations and modifications can be made to the embodiments without substantially departing from the principles of the present disclosure. All such variations and modifications are intended to be included herein within the scope of the present disclosure. Accordingly, the above disclosed subject matter is to be considered illustrative, and not restrictive, and the examples of embodiments are intended to cover all such modifications, enhancements, and other embodiments, which fall within the spirit and scope of the present disclosure. Thus, to the maximum extent allowed by law, the scope of the present disclosure is to be determined by the broadest permissible interpretation of the present disclosure including the examples of embodiments and their equivalents, and shall not be restricted or limited by the foregoing detailed description.

1. A method performed by a network node for adaptive resource dimensioning for a cloud stack having a plurality of virtualization layers with resource dependencies between the plurality of virtualization layers in an infrastructure, the method comprising:
assigning a workload to a bin in the infrastructure based on one of (i) assign the workload to the bin when the bin has a resource capacity that supports a dimension of the workload, the bin comprising one of an existing bin and an existing sub-bin within the bin, and (ii) when the resource capacity of the bin is insufficient to support the dimension of the workload (a) create a new bin, the new bin having a dimensioned resource capacity that supports the dimension of the workload, and (b) assign the workload to the new bin having the dimensioned resource capacity that supports the dimension of the workload; and
outputting information representing one of the assigned bin and the assigned new bin for the workload, and a corresponding resource capacity of the assigned bin or the dimensioned resource capacity of the new bin.

2. The method of claim 1, further comprising:
embedding the workload onto the assigned bin or the assigned new bin in the infrastructure.

3. The method of claim 1, wherein:
the existing bin and the new bin, respectively, comprise a bin that is adaptive over a period of time to be one or more of a physical server, a virtual machine, a virtualization layer from the plurality of virtualization layers, and an application for the workload or for another workload.

4. The method of claim 1, wherein the assigning the workload to a bin comprises:
performing a first process to find a server, the first process including (i) iterating through existing servers to select a server, and (ii) for a selected server, checking whether the selected server can host the workload; and
when checking whether the selected server can host the workload, performing a second process to find a bin of the server, the second process including checking whether a bin of the server can support and host the workload and whether the bin has the resource capacity to support the dimension of the workload; and performing one of (i) making the assignment to the bin of the server when the bin of the server has the resource capacity to support the dimension of the workload, and (ii) checking whether there is a sub-bin in the bin of the server that can host the workload when the bin of the server lacks the resource capacity to support the dimension of the workload.

5. The method of claim 4, wherein when the sub-bin of the server can host the workload, the method further comprising:
checking whether the sub-bin has the resource capacity to support the dimension of the workload; and
wherein the assigning comprises assigning the workload to the sub-bin when the sub-bin has the resource capacity to support the dimension of the workload.

6. The method of claim 4, further comprising:
when a server is not found in the first process that can host the workload, instantiating a new server that can support the workload;
recursively invoking the second process to find a bin; and
performing the second process, wherein the server in the second process is the new server.

7. The method of claim 1, wherein the create a new bin comprises
selecting a bin template for the workload;
dimensioning a capacity of the bin template to result in the dimensioned resource capacity that supports the dimension of the workload;
treating the selected bin template as the workload to recursively invoke the second process;
recursively invoking the second process; and
performing the second process, wherein the bin in the second process is the new bin.

8. The method of claim 4, further comprising:
when the bin in the second process lacks the resource capacity to support the dimension of the workload, performing a third process to extend the bin with an additional resource capacity; and
wherein the assigning comprises assigning the workload to the extended bin.

9. The method of claim 8, wherein the third process to extend the bin comprises
checking whether the bin can be extended with the additional resource capacity; and
performing one of (i) when the bin can be extended, extending the bin, and (ii) when the bin cannot be extended, checking whether the bin has a parent bin.

10. The method of claim 9, wherein when the bin has a parent bin, the method further comprising:
checking whether the parent bin can be extended;
when the parent bin can be extended, recursively invoking the third process to extend the bin; and
performing the third process, wherein the bin in the third process is the parent bin.

11. The method of claim 9, wherein the extending the bin comprises
calculating the additional resource capacity, wherein the calculating comprises one of (i) when the bin has a virtualization layer, determining a difference between the dimension of the workload and a residual capacity of the bin; and (ii) when the bin lacks a virtualization layer, determining the difference between the dimension of the workload and a residual capacity of the bin, and adding a virtualization overhead to the difference.

12. The method of claim 1, wherein the network node comprises one of an operation support system node and a business support system node.

13. A network node for adaptive resource dimensioning for a cloud stack having a plurality of virtualization layers with resource dependencies between the plurality of virtualization layers in an infrastructure, the network node comprising:
at least one processor;
at least one memory connected to the at least one processor and storing program code that is executed by the at least one processor to perform operations comprising:
assign a workload to a bin in the infrastructure based on one of (i) assign the workload to the bin when the bin has a resource capacity that supports a dimension of the workload, the bin comprising one of an existing bin and an existing sub-bin within the bin, and (ii) when the resource capacity of the bin is insufficient to support the dimension of the workload (a) create a new bin, the new bin having a dimensioned resource capacity that supports the dimension of the workload, and (b) assign the workload to the new bin having the dimensioned resource capacity that supports the dimension of the workload; and
output information representing one of the assigned bin and the assigned new bin for the workload, and a corresponding resource capacity of the assigned bin or the dimensioned resource capacity of the new bin.

14. The network node of claim 13, wherein the at least one memory connected to the at least one processor and storing program code that is executed by the at least one processor to perform further operations comprising:
embed the workload onto the assigned bin or the assigned new bin in the infrastructure.

15.-18. (canceled)

19. A computer program product comprising a non-transitory storage medium including program code to be executed by processing circuitry of a network node for a cloud stack having a plurality of virtualization layers with resource dependencies between the plurality of virtualization layers in an infrastructure, whereby execution of the program code causes the network node to perform operations comprising:
assign a workload to a bin in the infrastructure based on one of (i) assign the workload to the bin when the bin has a resource capacity that supports a dimension of the workload, the bin comprising one of an existing bin and an existing sub-bin within the bin, and (ii) when the resource capacity of the bin is insufficient to support the dimension of the workload (a) create a new bin, the new bin having a dimensioned resource capacity that supports the dimension of the workload, and (b) assign the workload to the new bin having the dimensioned resource capacity that supports the dimension of the workload; and
output information representing one of the assigned bin and the assigned new bin for the workload, and a corresponding resource capacity of the assigned bin or the dimensioned resource capacity of the new bin.

20. The computer program product of claim 19, whereby execution of the program code causes the network node to perform further operations comprising:
embed the workload onto the assigned bin or the assigned new bin in the infrastructure.

21. The network node of claim 13, wherein the existing bin and the new bin, respectively, comprise a bin that is adaptive over a period of time to be one or more of a physical server, a virtual machine, a virtualization layer from the plurality of virtualization layers, and an application for the workload or for another workload.

22. The network node of claim 13, wherein the assign the workload to a bin comprises perform a first process to find a server, the first process including (i) iterate through existing servers to select a server, and (ii) for a selected server, check whether the selected server can host the workload; and
when checking whether the selected server can host the workload, perform a second process to find a bin of the server, the second process including check whether a bin of the server can support and host the workload and whether the bin has the resource capacity to support the dimension of the workload; and perform one of (i) make the assignment to the bin of the server when the bin of the server has the resource capacity to support the dimension of the workload, and (ii) check whether there is a sub-bin in the bin of the server that can host the workload when the bin of the server lacks the resource capacity to support the dimension of the workload.

23. The network node of claim 22, wherein when the sub-bin of the server can host the workload, the at least one memory connected to the at least one processor and storing program code that is executed by the at least one processor to perform further operations comprising:
check whether the sub-bin has the resource capacity to support the dimension of the workload; and
wherein the assign comprises assign the workload to the sub-bin when the sub-bin has the resource capacity to support the dimension of the workload.

24. The network node of claim 22, wherein the at least one memory connected to the at least one processor and storing program code that is executed by the at least one processor to perform further operations comprising:
when a server is not found in the first process that can host the workload, instantiate a new server that can support the workload;
recursively invoke the second process to find a bin; and
perform the second process, wherein the server in the second process is the new server.
